(19) United States
(12) Patent Application Publication
(10) Pub. No.: US 2014/0137036 A1
(43) Pub. Date: May 15, 2014

(54) Operation Window for Portable Devices with Touchscreen Displays

(71) Applicant: Weishan Han, Katy, TX (US)

(72) Inventor: Weishan Han, Katy, TX (US)

(21) Appl. No.: 14/020,548

(22) Filed: Sep. 6, 2013

Related U.S. Application Data
(60) Provisional application No. 61/726,697, filed on Nov. 15, 2012.

(51) Int. Cl. G06F 3/0481

(52) U.S. Cl. CPC G06F 3/0481
USPC 715/798

(57) ABSTRACT

Novel tools and techniques are described for invoking and subsequently hiding or minimizing an operation window within a portion of a display area of a touchscreen display of a mobile device. The operation window may be invoked and hidden/minimized using default, preset, or customizable user inputs. The operation window, whose position, size, and content display options may be customizable by a user, allows a user to easily and comfortably interact with, operate, and/or navigate, using only one hand, software applications (e.g., user interfaces) running on a mobile device and displayed on the touchscreen display of the mobile device. This particular functionality is especially applicable to mobile devices having relatively large touchscreen displays that require two hands to comfortably operate while holding the mobile device.

### CROSS-REFERENCES TO RELATED APPLICATIONS

This application claims priority to U.S. Patent Application Ser. No. 61/726,697 (the “'697 application”), filed Nov. 15, 2012 by Weishan Han (attorney docket no. 0583.01-PR), entitled, “Operation Window for Portable Devices with Touchscreen Display,” the entire disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to smart phones and other portable devices with touchscreen displays, and more particularly, to methods, apparatuses, and computer software for allowing a user to operate, using one hand, the smart phones and other portable devices with touchscreen displays.

### BACKGROUND

Today, smart phones with large touchscreen displays are becoming more and more popular, with 4.5 inch (11.43 cm) display screens or larger already becoming the main stream screen sizes for Google® Android® based cellular or mobile phones (e.g., the Samsung® Galaxy S 3™ with a 4.8 inch (˜12.19 cm) display screen or the Samsung® Galaxy S 4™ with a 5 inch (˜12.7 cm)). Traditionally, Apple Inc. had limited its screen sizes to 3.5 inches (˜8.89 cm) (hereinafter referred to as the “3.5 inch law”), because the late founder and former CEO Steve Jobs had believed that 3.5 inches was the upper limit for one hand to easily navigate or operate a touchscreen display. However, even Apple Inc. has broken its 3.5 inch law, recently releasing a smart phone with a larger touchscreen display (namely, the iPhone 5™, which features a 4 inch (˜10.16 cm) display screen).

The larger display screens provide huge benefits to the user, such as a larger display area and easier navigation with two hands. However, the larger display screens also bring challenges. One major challenge is that it is very difficult to operate a mobile phone with a large touchscreen display with one hand while holding the mobile phone in the same hand. Even for a user with large hands, it is still very difficult to cover the entire 4.5 inch (˜11.43 cm) display area, or similarly sized or larger display area, with a single thumb of the user.

This problem is not limited to smart phones with large touchscreen displays, and is a problem inherent in other portable or mobile devices with large touchscreen displays—including, but not limited to, personal digital assistants (“PDAs”), tablet computers (like the Apple™ iPad®, the Apple™ iPad Mini, the Samsung® Galaxy Tab®, the Amazon™ Kindle Fire®, among others), and e-book readers (like the Amazon™ Kindle, the Barnes and Noble™ Nook®, among others), etc.

The embodiments disclosed herein are directed toward overcoming one or more of the problems discussed above.

### BRIEF SUMMARY

Various embodiments are intended and designed to allow a user to operate or navigate applications displayed on a relatively large touchscreen display of a mobile device by the use of one hand while holding the mobile device with the same hand. Herein, a relatively large touchscreen display refers to any touchscreen display that is difficult for a user to operate using only one hand (for example, but not limited to, a ˜3.5 inch (˜8.89 cm) touchscreen display).

The approach to implement these various aspects is to create an “operation window,” which is a specific window only for operation (or navigation) of the mobile device using one hand. When the user desires to operate the mobile device with one hand, such as using a full-keyboard input in a browser address bar, the user's input to do so will invoke an operation window. After completing the operation, the operation window may be hidden (e.g., hidden behind the main display window or minimized). In general, the operation window should be small enough to operate with one hand, but at the same time large enough to clearly display the screen information. The size of the operation window may be customizable by the user(s).

According to one aspect, a method for operating a mobile device with one hand comprises receiving a first input from a user (including, but not limited to, a hand swipe from the bottom-right-hand corner of the display screen toward the middle of the display screen or toward the upper-left-hand corner of the display screen, or a hand swipe from the bottom-left-hand corner of the display screen toward the middle of the display screen or toward the upper-right-hand corner of the display screen).

Upon receiving this input, the method invokes and displays an operation window in the display screen. In some embodiments, the operation window will be overlaid on the main display window. According to some embodiments, the operation window includes one of a miniature version of the main display window and a reformatted, resized representation of the contents displayed in the main display window. Reformatting and resizing may be in accordance with preset defaults that automatically resizes and reformats the main display window into the operation window, or may be in accordance to customizable user preferences for reformatting and resizing. In some embodiments, the method further comprises providing the user with options or the capability to modify the reformatting and resizing of the operation window after automatic reformatting and resizing (i.e., in accordance with preset defaults or with previously set user preferences), providing the user with options to reposition the operation window anywhere in the display screen, and receiving a second user input for customizing the size and position of the operation window. According to some embodiments, whatever is displayed on the operation window is projected or copied onto the main display window.

While the operation window is displayed, the method further includes receiving a third user input for interacting with (i.e., operating or navigating) the software application displayed in the operation window. After the operation is completed, the method further comprises receiving fourth user input from the user (including, but not limited to, an operation that is inverse or opposite to the operation of the first user input—i.e., a hand swipe from the middle or upper-left-hand corner of the display screen toward the bottom-right-hand corner of the display screen or toward the of the display screen, or a hand swipe from the middle or upper-right-hand corner of the display screen toward the bottom-left-hand corner of the display screen). Upon receiving the fourth user input, the method further comprises hiding the operation window, and the main display window will once again be prominently displayed.

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible, and/or non-transitory computer readable media (such as, to name but a few examples, optical media, magnetic media, and/or the like).

According to one aspect of the embodiments, a non-transitory computer readable medium is provided, the non-transitory computer readable medium having encoded thereon computer software for allowing a user to operate a mobile device using one hand. The computer software comprises a set of instructions that, when executed by a processor of the mobile device, causes the mobile device to perform one or more operations, the set of instructions comprising instructions to display a main screen window that fills a first portion of a display area of a touchscreen display of the mobile device with content. The content includes a user interface as well as any multimedia content, and the first portion of the display area comprises substantially all of the display area. The set of instructions further comprises instructions to receive first input from the user for invoking an operation window, and instructions to display the operation window in a second portion of the display area of the touchscreen display, in response to receiving the first input. The second portion of the display area is smaller in size than the first portion of the display area, and the operation window displays a representation of the content displayed on the main screen window. The representation comprises a representative user interface. The first input may include one of a hand swipe from a lower-right-hand corner of the display area to a middle portion of the display area or a hand swipe from a lower-left-hand corner of the display area to a middle portion of the display area.

The set of instructions further comprises instructions to receive second input from the user for customizing display preferences for at least one of a size of the operation window displayed in the display area, a position of the operation window displayed in the display area, or content display options for displaying the representation of the content within the operation window.

The set of instructions further comprises instructions to map input from the user interface displayed in the main screen window to the representative user interface displayed in the operation window. According to some embodiments, mapping of the input fields may be based at least in part on the display preferences.

The set of instructions further comprises instructions to receive third input from the user for interacting with the representative user interface displayed in the operation window. In some embodiments, the third input includes touch input within the second portion of the display area of the touchscreen display corresponding to the displayed operation window

In the case that the operation window is overlaid on the main screen window when displaying the operation window in the second portion of display area, the set of instructions further comprises instructions to update the main screen window based at least in part on the third input. An example of updating the main screen window may include projecting or reflecting any changes to the content displayed in the operation window onto the main screen window, which is in the background of the display area.

The set of instructions further comprises instructions to receive fourth input from the user for hiding the operation window, and instructions to hide the operation window in response to receiving the fourth input. The fourth input may include one of a hand swipe from a middle portion of the display area to a lower-right-hand corner of the display area or a hand swipe from a middle portion of the display area to a lower-left-hand corner of the display area.

In another aspect of the embodiments, a non-transitory computer readable medium is provided, the non-transitory computer readable medium having encoded thereon computer software for allowing a user to operate a mobile device using one hand. The computer software comprises a set of instructions that, when executed by a processor of the mobile device, causes the mobile device to perform one or more operations. The set of instructions comprises instructions to display a main screen window that fills a first portion of a display area of a touchscreen display of the mobile device with content, the first portion of the display area comprising substantially all of the display area. The set of instructions further comprises instructions to receive first input from the user for invoking an operation window and instructions to display the operation window in a second portion of the display area of the touchscreen display, in response to receiving the first input. The second portion of the display area is smaller in size than the first portion of the display area, and the operation window displays a representation of the content displayed on the main screen window.

According to yet another aspect of the embodiments, a mobile device is described that comprises a touchscreen display, a processor, and a non-transitory computer readable medium having encoded thereon a set of computer software for allowing a user to operate the mobile device using one hand. The computer software comprises a set of instructions that, when executed by a processor of the mobile device, causes the mobile device to perform one or more operations. The set of instructions comprises instructions to display a main screen window that fills a first portion of a display area of a touchscreen display of the mobile device with content, the first portion of the display area comprising substantially all of the display area. The set of instructions further comprises instructions to receive first input from the user for invoking an operation window, instructions to display the operation window in a second portion of the display area of the touchscreen display, in response to receiving the first input. The second portion of the display area is smaller in size than the first portion of the display area, and the operation window displays a representation of the content displayed on the main screen window.

In some embodiments, a size of the touchscreen display exceeds 3.5 inches as measured from one of a lower-left-hand corner of the display area of the touchscreen to an upper-right-hand corner of the display area or a lower-right-hand corner of the display area to an upper-left-hand corner of the display area. According to some embodiments, a size of the operation window does not exceed 3.5 inches as measured from one of a lower-left-hand corner of the second portion of the display area to an upper-right-hand corner of the second portion of the display area or a lower-right-hand corner of the second portion of the display area to an upper-left-hand corner of the portion of the second display area.

In accordance with still another aspect of the embodiments, a method is described that allows for operating, using one hand of a user, a mobile device having a touchscreen display. The method comprises invoking an operation window to overlay a main screen window displayed in a display area of the touchscreen display, in response to receiving first user input. In some embodiments, the first user input includes swiping a finger of the user from one of a lower-right-hand corner of the display area to a middle portion of the display area or a lower-left-hand corner of the display area to the middle portion of the display area. The method further comprises displaying, in the operation window, a representation of content displayed in the main screen window. The size of the operation window is smaller than a size of the main screen.

The method further comprises receiving second user inputs to interact with content displayed in the operation window, in which the content displayed in the operation window includes a representative user interface that represents a user interface displayed in the main screen window.

The method further comprises hiding the operation window, in response to receiving third user input indicating that the user has completed interacting with the content displayed in the operation window. In some embodiments, the third user input includes swiping the finger of the user from one of the middle portion of the display area to the lower-right-hand corner of the display area or the middle portion of the display area to the lower-left-hand corner of the display area.

The operation window is only displayed when needed. When it is needed, operation window is easy to pop in, comfortable to operate with one hand, and convenient and fast to pop out. From a software prospective, it is also not complicated to implement by one skilled in the art.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a generalized diagram illustrating a prior art mobile device 100.

FIGS. 2A-2C are generalized diagrams illustrating a mobile device 200 configured to allow a user to operate the touchscreen display input 205 using one hand, by invoking an operation window 220, in accordance with various embodiments.

FIGS. 3A-3E are generalized diagrams illustrating an example operation utilizing the mobile device 200 as shown in FIGS. 2A-2C, in accordance with various embodiments.

FIG. 4 is a flow chart illustrating a method 300 for allowing a user to operate a touchscreen display or a mobile device using one hand, by invoking an operation window, in accordance with various embodiments.

FIG. 5 is a block diagram illustrating hardware components within mobile device 400, some of which are configured to allow a user to operate a touchscreen display or a mobile device using one hand, by invoking an operation window, in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Hereinafter, the term, “operation window” refers to a display window displayed within a display area of the touchscreen display that is smaller in size than the touchscreen display area, and that represents information (e.g., an interactive software or applications user interface, multimedia content, and/or a combination of the two) displayed on a main screen window or main screen display (either as a miniature version thereof, or a reformatted and resized representation of the displayed content thereof). Accordingly, “main screen window” or “main screen display” refers to a display window that normally fills the touchscreen display area or a substantial portion thereof, and that is intended for normal operation of the mobile device. As is well understood in the art, “hiding” of a window refers to either hiding the subject window behind another display window or minimizing the subject window so that it is not displayed on the touchscreen display. As is also well understood in the art, the size of a screen of a mobile device is measured from one corner of a display area of the screen to an opposite corner of the display area (e.g., from a lower-left-hand corner to an upper-right-hand corner or from a lower-right-hand corner to an upper-right-hand corner). For example, a 4.5 inch (11.43 cm) display screen of a mobile phone is measured from one of a lower-left-hand corner to an upper-right-hand corner and from a lower-right-hand corner to an upper-right-hand corner of the display area of the mobile phone's display screen. In this disclosure, the terms, “hand swipe,” “finger swipe,” and “thumb swipe” (or similar phrases) are interchangeable, and refer to a user using his hand, finger, thumb, or stylus to interact with the touchscreen display to cause the software applications running on the mobile device to perform a particular task.

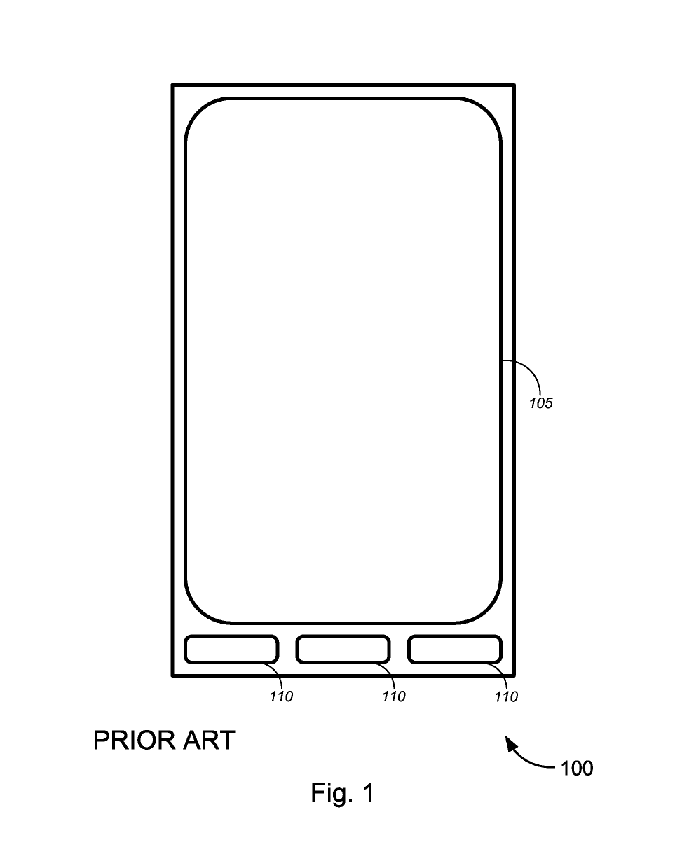

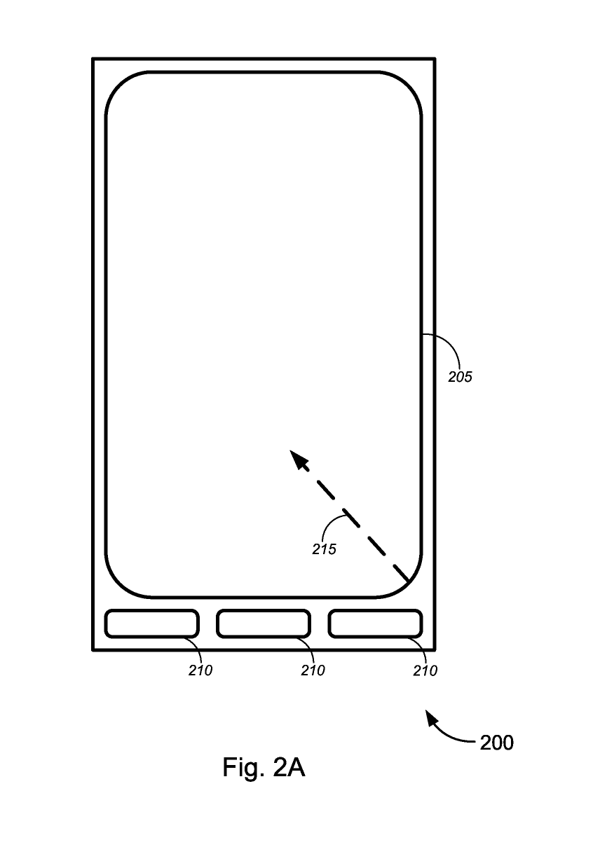

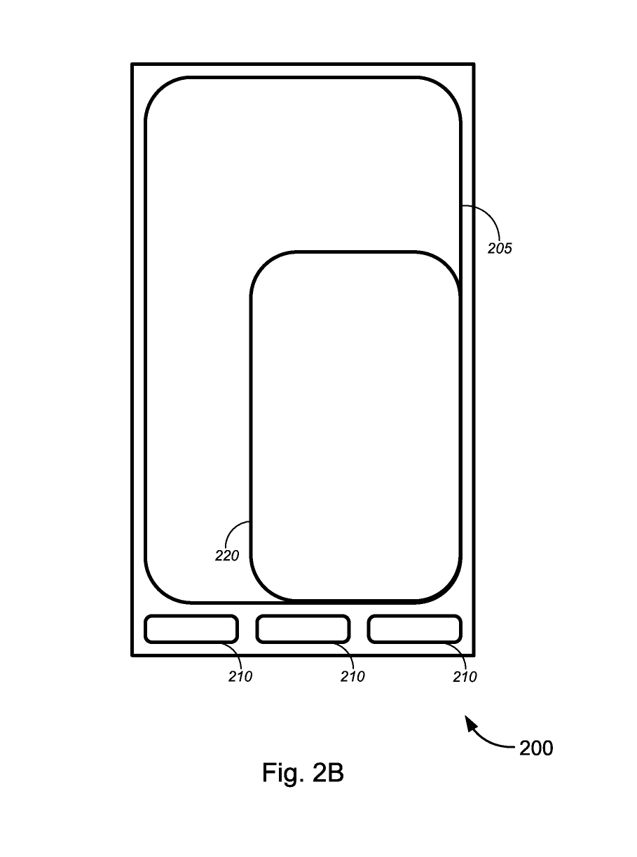

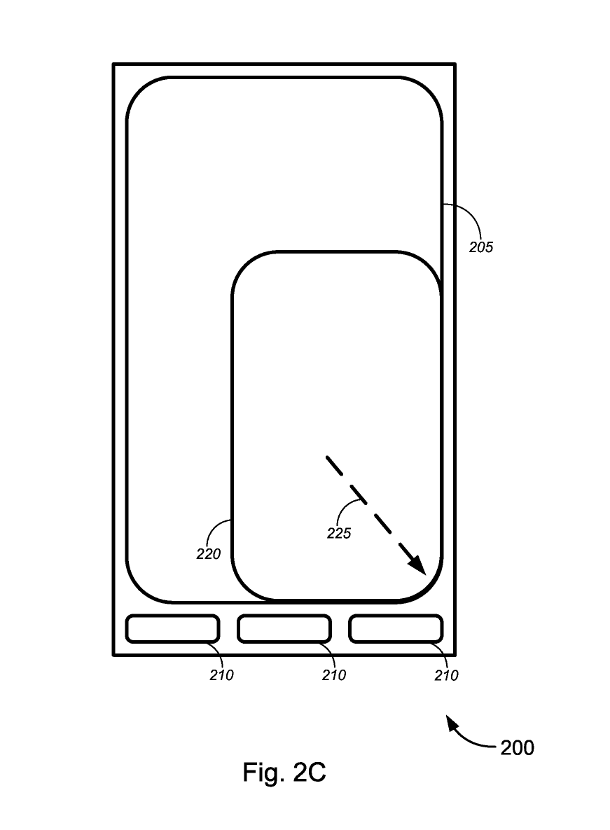

With reference to the figures, FIG. 1 is a generalized diagram illustrating a prior art mobile device 100. In FIG. 1, a prior art mobile device 100 includes a touchscreen display 105 and various hard or soft buttons 110. Touchscreen display 105 displays a main screen window that is sized to fill a substantial or entire display area of touchscreen display 105. In some mobile devices, such as smart phones (e.g., Google® Androie®-based mobile phones, like the Samsung® Galaxy S 3™ or Samsung® Galaxy S 4™, or Apple Inc.-based mobile phones, like the Apple™ iPhone 5™), the main screen window is divided into a plurality of screen panels. In such a case, one of the plurality of screen panels may be configured to fill the substantial or entire display area at any one time. As discussed above, as the size of the touchscreen display increases in subsequent models of smart phones, with screen sizes exceeding, e.g., 3.5 inches (˜8.89 cm), which is generally thought to be a comfortable size for a user to operate a touchscreen display with one hand, it becomes increasing more difficult for users to operate or navigate functions on their smart phones and other touchscreen mobile devices (e.g., tablet computers, PDAs, e-book readers, etc.) with a single hand. This problem is addressed in various embodiments as discussed below with respect to FIGS. 2A-5.

Referring to FIGS. 2A-2C (collectively, “FIG. 2”), FIGS. 2A-2C are generalized diagrams illustrating a mobile device 200 configured to allow a user to operate the touchscreen display 205 using one hand, by invoking an operation window 220, in accordance with various embodiments. In FIG. 2A, mobile device 200 includes a touchscreen display 205 and various hard or soft buttons 210. Touchscreen display 205 displays a main screen window that is sized to fill the substantial or entire display area of touchscreen display 205. In order to allow a user to navigate or operate functions displayed on the touchscreen display 205 using only one hand, particularly with display areas that are larger than ˜3.5 inches (˜8.89 cm), mobile device 200 is configured (e.g., by configuring the operating system of the mobile device 200 or by configuring a mobile device application (“app”) downloaded and installed on the mobile device) to allow the user to invoke an operation window 220 by, e.g., recognizing and receiving a user input 215.

According to some embodiments, user input 215 may include any customizable or preset inputs that are associated with the function of invoking operation window 220. For example, for a right-handed user, user input 215 may include a hand swipe that begins generally near the vicinity of the lower-right-hand corner of the display area toward the middle of the display area or toward the upper-left-hand corner of the display area. Such a diagonal hand swipe avoids conflicts with other hand swipe-operated functions such as horizontal left/right hand swipes that may already be associated with changing between a plurality of panels in a smart phone or vertical up/down hand swipes that may already be associated with viewing/closing status screens or viewing/closing menu/option screens. For a left-handed user, user input 215 may include a hand swipe that begins generally near the vicinity of the lower-left-hand corner of the display area toward the middle of the display area or toward the upper-right-hand corner of the display area. According to some embodiments, user input 215 may include user selection of an option selectable from a pop-up menu to invoke the operation window 220.

Turning to FIG. 2B, upon receiving user input 215, the mobile device 200 (or the processor therein) is configured to invoke and display on the touchscreen display 205 an operation window 220. Operation window 220 is configured to fill only a portion of the display area. Ideally, the size of the operation window 220 is configured to be large enough to clearly display the screen information on the main screen display, yet small enough to allow the user to operate (or navigate), using only a single hand, software applications (e.g., user interfaces, etc.) running on mobile device 200 and displayed on the touchscreen display 205. In some embodiments, the size of operation window 220 does not exceed ˜3.5 inches (˜8.89 cm), which is generally thought to be the upper limit for comfortable operation or navigation of a touchscreen display device with one hand. In some embodiments, the user may be provided with options and/or the capability to change, customize, or preset the size of the operation window 220. This may be done, e.g., by providing the user with access to user preferences that detail how the user would generally prefer to size the operation window. For example, this may be accomplished by allowing the user to press and hold down on a particular region of the operation window to invoke a menu screen that presents the user with options to resize the operation window 220. Alternatively, the resizing operation may be accomplished by allowing the user to hold down on and drag a particular portion of the operation window 220 (including, but not limited to, one or more corners of the operation window 220, or one or more of the top/bottom/side edges of the operation window 220) so as to resize the operation window 220.

According to some embodiments, the user may be provided with options and/or the capability to change, customize, or preset how content displayed on the operation window 220 will be resized and reformatted, or otherwise presented. This may be done, e.g., by providing the user with access to user preferences (which may be the same as those for resizing the operation window 220) that detail how the user would generally prefer the content of the operation window to be resized, reformatted, or otherwise presented in the operation window 220. Alternatively, the resizing/reformatting operation may be accomplished by allowing the user to press and hold on a particular region of the operation window to invoke a menu screen that presents the user with options to resize, reformat, or otherwise present the content on the operation window 220. In some embodiments, if no customized configuration is available or otherwise provided by the user, the default operation window displays the exact same image as the main display area, but in smaller dimensions. In accordance with some embodiments, content display options include options selected from a group consisting of resizing the content while locking an aspect ratio of the content, reformatting font and content sizes to fit a size and shape of the operation window based on predetermined criteria, and rearranging icons or multimedia content in the operation window to fit the size and shape of the operation window based on predetermined criteria. Predetermined criteria may include default or user preset criteria that designate rules for how to reformat the font and content based on ranges of sizes of the operation window and based on the shapes of the operation window. Predetermined criteria may also include default or user preset criteria that designate rules for how to rearrange icons or multimedia content based on ranges of sizes of the operation window and based on the shapes of the operation window.

As shown in FIG. 2B, the operation window 220 is shown positioned generally at the lower-right-hand corner of the touchscreen display 205. However, the operation window 220 may be positioned or repositioned anywhere within the display area of touchscreen display 205. For example, for a left-handed user, positioning the operation window 220 generally at the lower-left-hand corner of the display area of touchscreen display 205 would be more appropriate and more comfortable for the left-handed user. Alternatively, the operation window 220 may be positioned along one of the top, bottom, right, or left sides, but not the corners, of the display area of the touchscreen display 205, or generally at the upper-left-hand corner or the upper-right-hand corner of the display area of the touchscreen display 205. In some embodiments, the operation window 220 may be displayed in a middle region of the display area, i.e., anywhere in the display area that is not abutting any of the top, bottom, right, or left sides of the display area, or any of the upper-left-hand, upper-right-hand, lower-left-hand, or lower-right-hand corners of the display area.

According to some embodiments, the user may be provided with options and/or the capability to change, customize, or preset the position of the operation window 220 to be displayed or that is displayed in the display area of touchscreen display 205. This may be done, e.g., by providing the user with access to user preferences (which may be the same as those for resizing the operation window 220 and for resizing, reformatting, or otherwise presenting content in the operation window 220) that detail how the user would generally prefer to position the operation window 220. Alternatively, the position/reposition of the operation window 220 may be accomplished by allowing the user to press and hold on a particular region of the operation window to invoke a menu screen that presents the user with options to position or reposition the operation window 220. In some embodiments, the positioning/repositioning operation may be performed by allowing the user to hold down on and drag a particular portion of the operation window 220 (including, but not limited to, one or more corners of the operation window 220, or one or more of the top/bottom/side edges of the operation window 220, or a middle (i.e., non-edge, non-corner) portion of the operation window 220) so as to reposition the operation window 220 to another part of the display area of touchscreen display 205.

According to some embodiments, the main screen, whose content is presented on the operation window 220 (e.g., in a reformatted, resized, or otherwise presented form), may continue to be displayed in the background, underneath the operation window 220. In some embodiments, any changes in the display of content in the operation window 220 may be projected, reflected, or otherwise displayed in the main screen display, which is in the background of the display, underneath the operation window 220. In accordance with some embodiments, the projection, reflection, or display of any changes in the display of content in the operation window 220 onto the main screen display is either immediate (or instant) or may lag by a measurable processor delay time. In some alternative embodiments, the main screen display may be hidden and replaced with a customizable background (e.g., a preset or default or customized wallpaper, or a preset or default or customized screensaver, either or both of which may be static or dynamic), with the operation window 220 overlaid on the customizable background.

With reference to FIG. 2C, after the user has interacted with, operated, and/or navigated the software application (e.g., user interface) running on the mobile device 200 and displayed on the operation window 220, and intends to return to the main screen display, the mobile device 200 (or the processor therein) is configured to allow the user to hide or minimize the operation window 220, by recognizing and receiving a user input 225. According to some embodiments, the user input 225 may include any customizable or preset inputs that are associated with the function of hiding or minimizing operation window 220. For example, for a right-handed user, user input 225 may include a hand swipe that begins generally near the vicinity of the middle of the display area toward the lower-right-hand corner of the display area. As with the diagonal hand swipe for user input 215, such a diagonal hand swipe for user input 225 avoids conflicts with other hand swipe-operated functions such as horizontal left/right hand swipes that may already be associated with changing between a plurality of panels in a smart phone or vertical up/down hand swipes that may already be associated with viewing/closing status screens or viewing/closing main screens. For a left-handed user, user input 225 may include a hand swipe that begins generally near the vicinity of the middle of the display area toward the lower-left-hand corner of the display area. According to some embodiments, user input 225 may include user selection of an option selectable from a pop-up menu to hide and/or minimize the operation window 220.

In an exemplary embodiment, user input 225 may include a variation of the resizing operation as discussed above in relation to FIG. 2B. In such a resizing operation, if the user input 225 positions the operation window 220 so as to abut one of the four corners of the display area (in the case that the operation window 220 is positioned in the middle portion of the display area that is not abutting any of the four sides or four corners of the display area), and drags the corner of the operation window 220 that is in the middle of the display area from the middle region to one of the four corners of the display area (i.e., one of the upper-left-hand corner, the upper-right-hand corner, the lower-left-hand corner, and the lower-right-hand-corner of the display area) of touchscreen 205, the mobile device 200 (or the processor therein) will either replace the main screen with the full-size operation window 220 (which becomes the new main screen), hide/minimize the operation window 220 and display the main screen, or simply overlap the full-size operation window 220 on top of the main screen.

With the operation window 220 hidden or minimized, the main screen may be revealed to fill the substantial or entire display area of the touchscreen display 205. In the embodiments where the main screen is replaced with a static/dynamic screensaver or wallpaper, the operation for hiding or minimizing the operation window 220 may invoke or otherwise cause the display of the main screen so as to fill the substantial or entire display area of the touchscreen display 205.

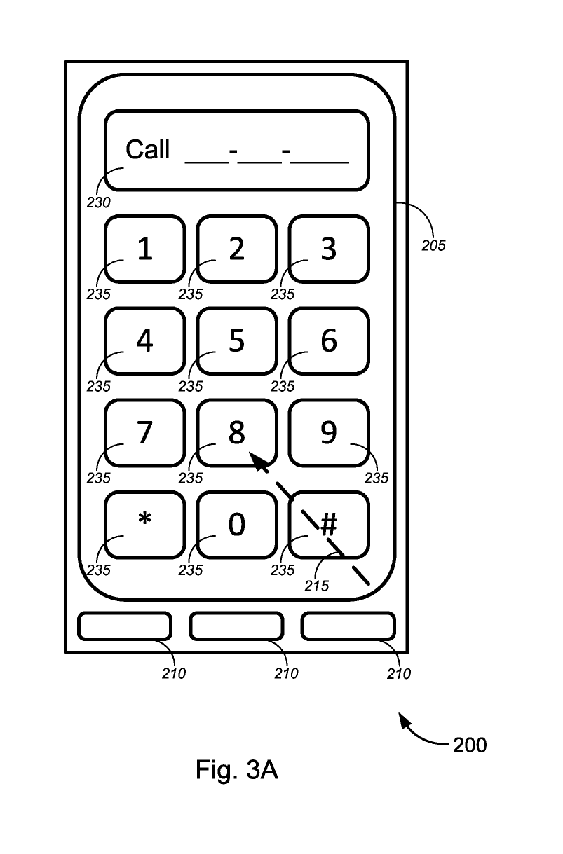

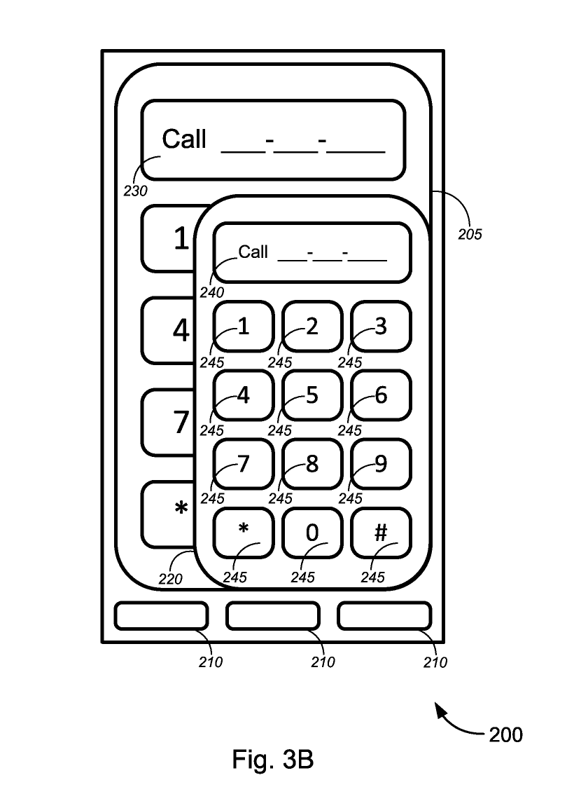

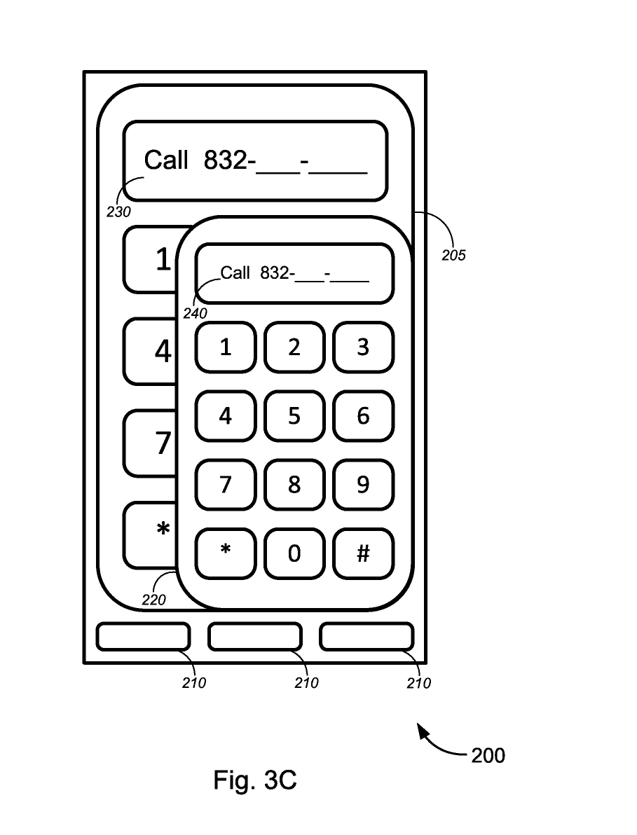

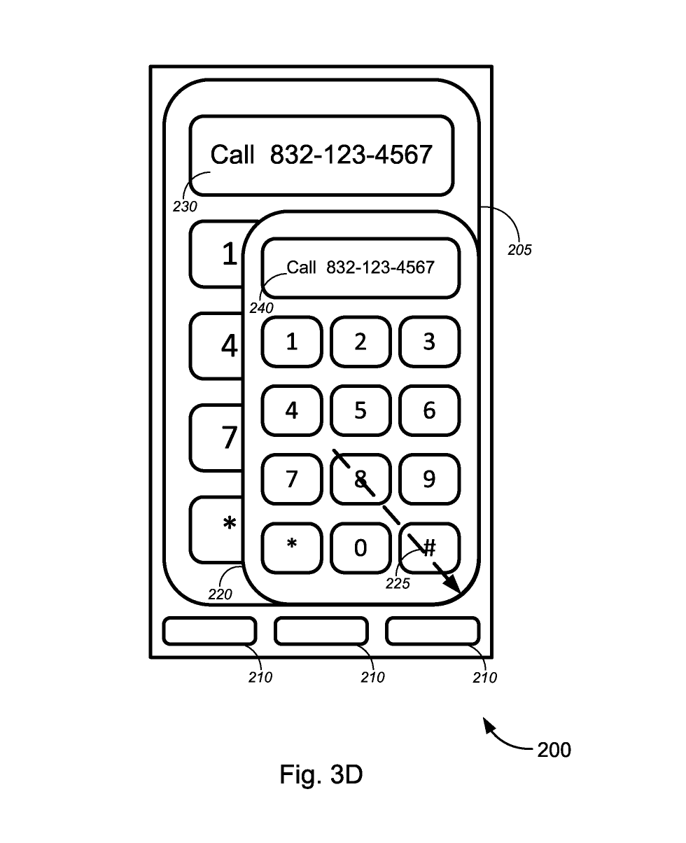

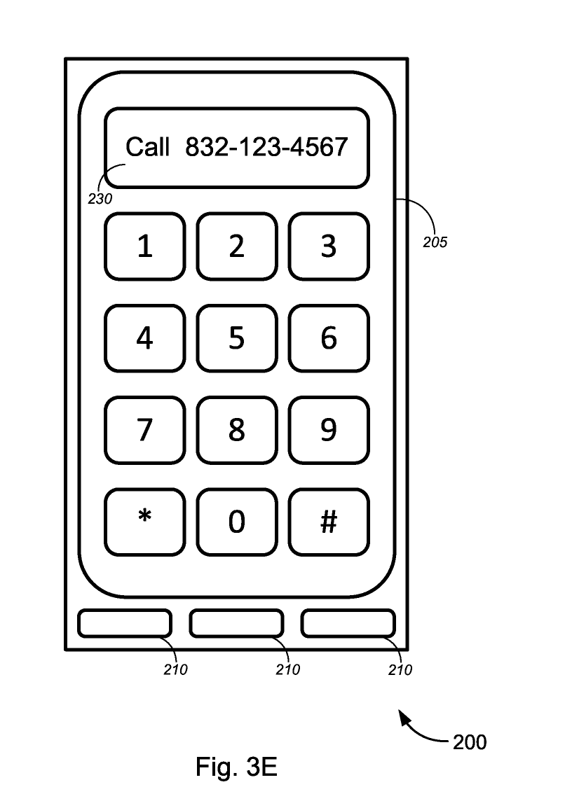

With reference to FIGS. 3A-3E (collectively, “FIG. 3”), FIGS. 3A-3E are generalized diagrams illustrating an example operation utilizing the mobile device 200 as shown in FIG. 2, in accordance with various embodiments. In particular, FIG. 3 illustrates various embodiments in which the user desires to make a telephone call on a smart phone having a relatively large touchscreen display (i.e., a touchscreen display that exceeds, e.g., ˜3.5 inches (˜8.89 cm) in size). This operation is merely an example. Other operations that may benefit from the use of the operation window may include, but are not limited to, taking a photograph using the camera, recording a voice input using the microphone, browsing the Internet, inputting text into one or more text fields of a user interface, navigating using a user interface of a global positioning system (“GPS”) software app, entering inputs for interacting with gaming software or gaming apps, etc. The operation of invoking and hiding/minimizing the operation window 220 is as discussed above with respect to FIGS. 2A-2C.

In FIG. 3A, the main screen contains a telephone dialing screen, in which is displayed a calling or destination number display region 230 (hereinafter, “call display region 230”), and soft buttons 235 representing the number pad including the ten different Arabic numbers from 0 through 9 as well as the pound (“#”) and star (“*”) keys (hereinafter, “number pad buttons 235”). By entering user input 215 (e.g., a hand swipe from the lower-right-hand corner of the display area toward the middle or upper-left-hand corner of the display area; or a hand swipe from the lower-left-hand corner of the display area toward the middle or upper-right-hand corner of the display area), the user invokes operation window 220 (shown in FIG. 3B). As discussed above, user input 215 may include other inputs by the user other than the specific hand swipes mentioned that are associated with invoking the operation window 220

Turning to FIG. 3B, invoking operation window 220 causes operation window 220 to be displayed overlaying the main screen. In this exemplary embodiment, the contents of the main screen are reformatted, resized, or otherwise presented in the operation window 220, according to preset, default, or user customizable resizing, repositioning, and presentation options as discussed above in relation to FIG. 2B. As shown in FIG. 3B, for example, a default or preset (preference) setting may be for the operation window to be located generally at (or abutting) the lower-right-hand corner of the display area (although in some embodiments, the operation window 220 may be preset to be positioned generally at (or abutting) the lower-left-hand corner of the display area). In FIG. 3B, call display region 230 and number pad buttons 235 are resized and reformatted to fit the size of operation window 220, and are subsequently displayed or otherwise presented in the operation window 220 as call display region 240 and number pad buttons 245, respectively.

Referring to FIG. 3C, a right-handed user may input a telephone number using a finger of a single hand (i.e., his or her right thumb). For example, as shown in FIG. 3C, the user may enter the numbers “8,” “3,” and “2” using number pad buttons 245. For a left-handed user, the operation window 220 would be positioned generally at (or abutting) the lower-left-hand corner of the display area to allow the left-handed person to more comfortably and/or more easily enter the telephone number with his or her left thumb.

According to some embodiments, the main screen may continue to be displayed in the background. In some embodiments, the numbers “8,” “3,” and “2” that are entered using number pad buttons 245 and displayed on call display region 240 may be projected, reflected, or otherwise displayed on the main screen in call display region 230. The projection, reflection, or other display on call display region 230 of each of the numbers entered using the number pad buttons 245 may be performed roughly, almost simultaneously, approximately concurrently, or exactly concurrently with the display of each number on call display region 240.

As shown in FIG. 3D, once the user has completed interacting, operating, and/or navigating the functions of the software application (e.g., user interface) displayed on the operation window 220, the user may hide or minimize the operation window 220 by entering user input 225 (e.g., a hand swipe from the middle of the display area toward the lower-right-hand corner of the display area; or a hand swipe from the middle of the display area toward the lower-left-hand corner of the display area). As discussed above, user input 225 may include other inputs by the user other than the specific hand swipes mentioned that is associated with hiding or minimizing the operation window 220.

Turning to FIG. 3E, upon receiving the user input 225, the mobile device (or the processor therein) causes the processor to hide or minimize the operation window 220, thus leaving the main screen to fill the substantial or entire display area of the touchscreen display 205.

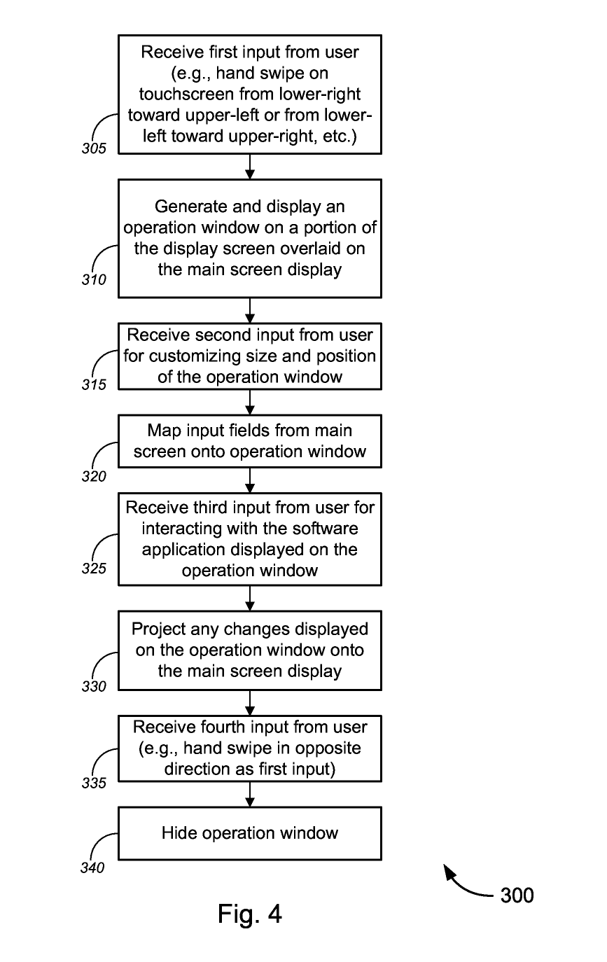

We turn now to FIG. 4. FIG. 4 is a flow chart illustrating a method 300 for allowing a user to operate a touchscreen display or a mobile device using one hand, by invoking an operation window, in accordance with various embodiments. At block 305, the method includes receiving a first input or a first set of inputs 215 from the user (including, but not limited to a diagonal hand swipe from either the lower-right-hand corner toward the middle or the upper-left-hand corner, a diagonal hand swipe from either the lower-left-hand corner toward the middle or the upper-right-hand corner, selecting to invoke the operation window 220 from a menu option, etc.). Upon receiving user input 215, the method includes generating and displaying an operation window 220 on a portion of the display screen (at block 310). In some embodiments, the operation window 220 may be overlaid on one of the main screen (the contents of which are reformatted, resized, or otherwise presented in the operation window 220), a static/dynamic wallpaper, or a static/dynamic screensaver. At block 315, a second input or a second set of inputs is received from the user for customizing the size and position of the operation window 220. The second input or second set of inputs may also include options for customizing how the content from the main screen may be reformatted, resized, or otherwise displayed in the operation window 220. The functionality at block 315 may be optional, as preset or default sizing, positioning, and content formatting options may be invoked if the user does not enter the second input or a second set of inputs within an predetermined time period (e.g., 1, 2, or 3 seconds) after invoking the operation window 220 at block 305. Alternatively, the functionality at block 315 may be implemented any time after the operation window 220 has been invoked and displayed.

At block 320, the input fields from the main screen are mapped onto the operation window 220. In other words, due to the resizing (i.e., general miniaturizing) or reformatting (i.e., general or slight changing of the interactive icons, etc.), the input fields on the operation window 220 must be reconfigured so that the user who would normally touch a particular region on the main screen to cause a function to be performed can touch a particular region in the operation window 220 corresponding to said particular region on the main screen. With reference to FIGS. 3B-3D, for example, a user who intends to type the number “8” on the number pad button 235, and who would normally touch the particular region of the main screen corresponding to the number pad button 235 for the number “8,” would instead touch the particular region of the operation window 220 corresponding to number pad button 245 corresponding to the number “8.” Accordingly, the input fields for the number pad button 235 for number “8” on the main screen must be mapped onto the number pad button 245 for number “8” on the operation window 220, and so on.

Once the input mapping has been completed, the method receives a third input or a third set of inputs from the user for interacting with, operating, and/or navigating the software application that is displayed on the operation window 220 (at block 325). In the embodiments in which the main screen continues to be displayed underneath the operation window 220 (i.e., in the background of the display), at block 330, any changes displayed on the operation window 220 may be projected, reflected, or otherwise displayed on the main screen display that is in the background.

After the user has completed interacting with, operating, and/or navigating the software application (e.g., user interface) that is displayed in the operation window 220, the method receives a fourth input or a fourth set of inputs 225 from the user (including, but not limited to a diagonal hand swipe from the middle toward the lower-right-hand corner, a diagonal hand swipe from the middle toward the lower-left-hand corner, selecting to hide or minimize the operation window 220 from a menu option, etc.) for hiding or minimizing the operation window 220. At block 340, upon receiving fourth input 225, the operation window 220 is hidden or minimized.

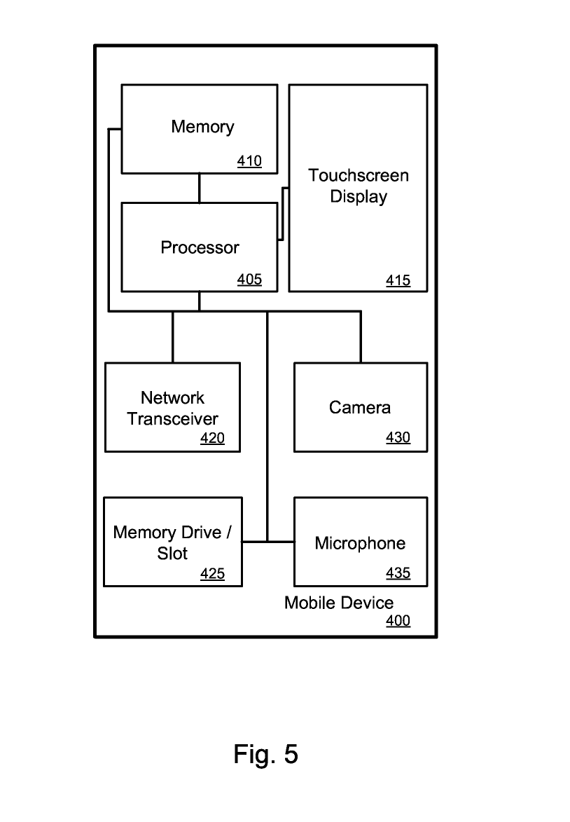

Referring now to FIG. 5, FIG. 5 is a block diagram illustrating hardware components within mobile device 400, some of which are configured to allow a user to operate a touchscreen display or a mobile device using one hand, by invoking an operation window, in accordance with various embodiments. In FIG. 5, a block diagram of an exemplary mobile device 400 is shown that includes at least one of processor 405, memory 410, and touchscreen display 415. Processor 405 may be configured to execute software, such as an operating system of the mobile device, to cause the mobile device 400 to invoke and display operation window 220 in a portion of the display area of touchscreen display 415 in response to receiving user input 215. Any presets, defaults, or other settings for sizing/resizing, positioning/repositioning, formatting/reformatting, or otherwise presenting the operation window 220 and/or the content displayed therein within the display area of touchscreen display 415 may be stored in memory 410. Memory 410 may include a RAM, a PROM, an EPROM, a FLASH-EPROM, or any other memory chip or cartridge, a carrier wave (e.g., electromagnetic signals, acoustic signals, optical signals, and/or the like), or any other medium from which a computer or a mobile device can read instructions and/or code.

According to some embodiments, mobile device 400 may further include at least one of network transceiver 420, memory drive or slot 425, camera 430, or microphone 435. In some embodiments, the network transceiver 420 may be used to update, over a wireless network connection, the software (e.g., operating system or mobile device application (“app”)) that allows the user to invoke/hide/minimize an operation window according to various embodiments discussed above. The various presets, defaults, or other settings for sizing/resizing, positioning/repositioning, formatting/reformatting, or otherwise presenting the operation window 220 and/or the content displayed therein within the display area of touchscreen display 415 may also be downloaded from a network (e.g., the Internet; a local area network (“LAN”), including without limitation a fiber network, an Ethernet network, a Token-Ring™ network and/or the like; a wide area network (“WAN”); a wireless wide area network (“WWAN”); a virtual network, such as a virtual private network (“VPN”); a personal area network (“PAN”); an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks) over a wireless network connection via network transceiver 420.

In some embodiments, the software (e.g., operating system or mobile device application (“app”)) and/or the presets, defaults, or other settings for sizing/resizing, positioning/repositioning, formatting/reformatting, or otherwise presenting the operation window 220 and/or the content displayed therein within the display area of touchscreen display 415 may be stored on, and transferred to the mobile device 400 via, an external memory device (e.g., a solid state memory drive, including, but not limited to, a secure digital (“SD”) card or micro SD card, a flash memory drive, etc.). In such a case, memory drive or slot 425 may be configured to receive and connect with corresponding contact points on the external memory device, for transferring the software and/or the presets, defaults, or other settings from the external memory device to the memory 410.

According to some embodiments, camera 430 or microphone 435 (or the settings for either component) may be controlled using an operation window 220 that is invoked according to various embodiments discussed above.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware, and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A non-transitory computer readable medium having encoded thereon computer software for allowing a user to operate a mobile device using one hand, the computer software comprising a set of instructions that, when executed by a processor of the mobile device, causes the mobile device to perform one or more operations, the set of instructions comprising:
instructions to display a main screen window that fills a first portion of a display area of a touchscreen display of the mobile device with content, the content including a user interface, and the first portion of the display area comprising substantially all of the display area;
instructions to receive first input from the user for invoking an operation window;
instructions to display the operation window in a second portion of the display area of the touchscreen display, in response to receiving the first input, the second portion of the display area being smaller in size than the first portion of the display area, and the operation window displaying a representation of the content displayed on the main screen window, the representation comprising a representative user interface;
instructions to receive second input from the user for customizing display preferences for at least one of a size of the operation window displayed in the display area, a position of the operation window displayed in the display area, or content display options for displaying the representation of the content within the operation window;
instructions to map input from the user interface displayed in the main screen window to the representative user interface displayed in the operation window, based at least in part on the display preferences;
instructions to receive third input from the user for interacting with the representative user interface displayed in the operation window, wherein the third input includes touch input within the second portion of the display area of the touchscreen display corresponding to the displayed operation window;
instructions to update the main screen window based at least in part on the third input;
instructions to receive fourth input from the user for hiding the operation window; and
instructions to hide the operation window in response to receiving the fourth input.

2. A non-transitory computer readable medium having encoded thereon computer software for allowing a user to operate a mobile device using one hand, the computer software comprising a set of instructions that, when executed by a processor of the mobile device, causes the mobile device to perform one or more operations, the set of instructions comprising:
instructions to display a main screen window that fills a first portion of a display area of a touchscreen display of the mobile device with content, the first portion of the display area comprising substantially all of the display area;
instructions to receive first input from the user for invoking an operation window; and
instructions to display the operation window in a second portion of the display area of the touchscreen display, in response to receiving the first input, the second portion of the display area being smaller in size than the first portion of the display area, and the operation window displaying a representation of the content displayed on the main screen window.

3. The non-transitory computer readable medium of claim 2, wherein the content displayed in the main screen window includes a user interface, and wherein the representation comprises a representative user interface.

4. The non-transitory computer readable medium of claim 3, the set of instructions further comprising:
instructions to map input from the user interface displayed in the main screen window to the representative user interface displayed in the operation window, based at least in part on display preferences.

5. The non-transitory computer readable medium of claim 2, wherein the first input includes one of a single user input and a set of user inputs.

6. The non-transitory computer readable medium of claim 5, wherein the first input includes one of a hand swipe from a lower-right-hand corner of the display area to a middle portion of the display area or a hand swipe from a lower-left-hand corner of the display area to a middle portion of the display area.

7. The non-transitory computer readable medium of claim 5, wherein the first input includes user selection of an option selectable from a pop-up menu to invoke the operation window.

8. The non-transitory computer readable medium of claim 2, wherein displaying the operation window in a portion of the display area of the touchscreen display includes displaying the operation window in one of a middle portion of the display area without abutting any corner or edge of the display area or a position in which the operation window abuts one of an upper-left-hand corner of the display area, an upper-right-hand corner of the display area, a lower-left-hand corner of the display area, a lower-right-hand corner of the display area, an upper edge of the display area without abutting a corner of the display area, a lower edge of the display area without abutting a corner of the display area, a left-side edge of the display area without abutting a corner of the display area, or a right-side edge of the display area without abutting a corner of the display area.

9. The non-transitory computer readable medium of claim 2, wherein displaying the operation window in the second portion of the display area of the touchscreen display includes displaying the operation window in accordance with at least one of default settings for sizing and positioning the operation window in the display area or preset user preferences for sizing and positioning the operation window in the display area.

10. The non-transitory computer readable medium of claim 2, wherein displaying the representation of the content displayed on the main screen window includes displaying the representation in accordance with at least one of default settings for resizing, reformatting, or displaying the content in the operation window or preset user preferences for resizing, reformatting, or displaying the content in the operation window.

11. The non-transitory computer readable medium of claim 2, the set of instructions further comprising:
instructions to receive second input from the user for customizing display preferences for at least one of a size of the operation window displayed in the display area, a position of the operation window displayed in the display area, or content display options for displaying the representation of the content within the operation window.

12. The non-transitory computer readable medium of claim 11, wherein the content display options include options selected from a group consisting of resizing the content while locking an aspect ratio of the content, reformatting font and content sizes to fit a size and shape of the operation window based on predetermined criteria, and rearranging icons or multimedia content in the operation window to fit the size and shape of the operation window based on predetermined criteria.

13. The non-transitory computer readable medium of claim 11, the set of instructions further comprising:
instructions to map input from the content displayed in the main screen window to the representation of the content displayed in the operation window, based at least in part on the display preferences.

14. The non-transitory computer readable medium of claim 2, the set of instructions further comprising:
instructions to receive third input from the user for interacting with the representation of the content displayed in the operation window,
wherein the third input includes touch input within the second portion of the display area of the touchscreen display corresponding to the displayed operation window.

15. The non-transitory computer readable medium of claim 2, wherein displaying the operation window in the second portion of the display area of the touchscreen display includes displaying the operation window overlaid on the main screen window, and wherein the set of instructions further comprises:
instructions to update the main screen window based at least in part on the third input.

16. The non-transitory computer readable medium of claim 2, wherein displaying the operation window in the second portion of the display area of the touchscreen display includes displaying the operation window overlaid on one of a wallpaper or a screensaver, wherein each of the wallpaper and screensaver is one of static or dynamic.

17. The non-transitory computer readable medium of claim 2, the set of instructions further comprising:
instructions to receive fourth input from the user for hiding the operation window; and
instructions to hide the operation window in response to receiving the fourth input.

18. The non-transitory computer readable medium of claim 17, wherein the fourth input includes one of a hand swipe from a middle portion of the display area to a lower-right-hand corner of the display area or a hand swipe from a middle portion of the display area to a lower-left-hand corner of the display area.

19. The non-transitory computer readable medium of claim 17, wherein the fourth input includes user selection of an option selectable from a pop-up menu to hide the operation window.

20. The non-transitory computer readable medium of claim 17, wherein the fourth input includes user input to change a size of the operation window to fill the first portion of the display area.

21. A mobile device, comprising:
a touchscreen display;
a processor; and
a non-transitory computer readable medium having encoded thereon a set of computer software for allowing a user to operate the mobile device using one hand, the computer software comprising a set of instructions that, when executed by the processor of the mobile device, causes the mobile device to perform one or more operations, the set of instructions comprising:
instructions to display a main screen window that fills a first portion of a display area of a touchscreen display of the mobile device with content, the first portion of the display area comprising substantially all of the display area;
instructions to receive first input from the user for invoking an operation window; and
instructions to display the operation window in a second portion of the display area of the touchscreen display, in response to receiving the first input, the second portion of the display area being smaller in size than the first portion of the display area, and the operation window displaying a representation of the content displayed on the main screen window.

22. The mobile device of claim 21, wherein a size of the touchscreen display exceeds 3.5 inches as measured from one of a lower-left-hand corner of the display area of the touchscreen to an upper-right-hand corner of the display area or a lower-right-hand corner of the display area to an upper-left-hand corner of the display area.

23. The mobile device of claim 21, wherein a size of the operation window does not exceed 3.5 inches as measured from one of a lower-left-hand corner of the second portion of the display area to an upper-right-hand corner of the second portion of the display area or a lower-right-hand corner of the second portion of the display area to an upper-left-hand corner of the second portion of the display area.

24. A method for operating, using one hand of a user, a mobile device having a touchscreen display, comprising:
invoking an operation window to overlay a main screen window displayed in a display area of the touchscreen display, in response to receiving first user input;
displaying, in the operation window, a representation of content displayed in the main screen window, wherein a size of the operation window is smaller than a size of the main screen;
receiving second user inputs to interact with content displayed in the operation window, wherein the content displayed in the operation window includes a representative user interface that represents a user interface displayed in the main screen window; and
hiding the operation window, in response to receiving third user input indicating that the user has completed interacting with the content displayed in the operation window.

25. The method of claim 24, wherein the first user input includes swiping a finger of the user from one of a lower-right-hand corner of the display area to a middle portion of the display area or a lower-left-hand corner of the display area to the middle portion of the display area, and wherein the third user input includes swiping the finger of the user from one of the middle portion of the display area to the lower-right-hand corner of the display area or the middle portion of the display area to the lower-left-hand corner of the display area.

26. The method of claim 24, further comprising:
receiving fourth user inputs to customize at least one of a size of the operation window displayed in the portion of the display area, a position of the operation window displayed in the portion of the display area, and content display options for displaying the representation of the content within the operation window,
wherein the content display options include options selected from a group consisting of resizing the content while locking an aspect ratio of the content, reformatting font and content sizes to fit the size and a shape of the operation window based on predetermined criteria, and rearranging icons or multimedia content in the operation window to fit the size and the shape of the operation window based on predetermined criteria.
